(19) United States
(12) Patent Application Publication
(10) Pub. No.: US 2003/0157838 A1
(43) Pub. Date: Aug. 21, 2003

(54) Device for interconnecting network segment cable to network tester or analyzer

(76) Inventors: William T. Eberle, East Syracuse, NY (US); Robert A. Blackman, Central Square, NY (US); Bradford S. Dombrowsky, Baldwinsville, NY (US)

Correspondence Address: HANCOCK & ESTABROOK, LLP, 1500 MONY Tower I, PO Box 4976, Syracuse, NY, 13221-4976, US

(21) Appl. No.: 10/078,767

(22) Filed: Feb. 19, 2002

(51) Int. Cl. H01R 13/66

(52) U.S. Cl. 439/620

(57) ABSTRACT

The present invention provides a device for interconnecting a series of computer network cables to a computer network analyzer. The device comprises an upper chassis and a lower chassis that are interconnected to one another in part via a pair of corresponding tracks and channels, and in part via mating interconnect members. The upper chassis includes a printed circuit board attached to its plate that contains a plurality of passive circuit components, including passive network cable connectors and other passive components, and incorporates standard network cable connectors into its rear panel. The lower chassis contains a printed circuit board with active switch and testing/analyzing components disposed thereon.

### BACKGROUND OF THE INVENTION

1. Field of Invention

The present invention relates generally to computer network system analyzers, and more particularly to rack mounted analysis equipment that interconnects computer network cables to network analysis equipment (or network testing equipment, synonymously referred to herein an “analyzers”).

2. Prior Art

Traditionally, data flow across computer networks is often monitored with some form of testing or analysis circuitry and software. For instance, a network analyzer may monitor traffic across a network by reading data at various junctions, or nodes, in the network. If a problem with the network arises, a network administrator may look at the monitoring results of the analyzer and quickly determine where on the network the problem is occurring. The “problem node” can then be disconnected from the network and fixed, thereby maintaining the network in operable condition for the maximum time possible.

The manner in which this monitoring is done includes an analyzing/testing computer to which each segment in a network is interconnected. The analyzer/tester is connected to a printed circuit board containing switching and control circuitry. The printed circuit board is housed in a cabinet which is positioned in a network rack containing other analyzers. The network segment cables are directly connected to the printed circuit boards via industry standard network interconnects, which may include, for example, 8-pin modular connectors for LAN environments or SC connectors for fiber based networks. In this arrangement, however, if the active circuit board malfunctions, loses power, or needs replacement, the network segments connected thereto must be disconnected therefrom. When this occurs, the network is “down” until all the connections can be restored, which may take a long period of time.

3. Objects and Advantages of the Invention

It is therefore a principal object and advantage of the present invention to provide a network test or analyzer device that permits network segment connections to be maintained in the event of the active board losing power, needing replacement, or requiring other maintenance.

It is another object and advantage of the present invention to provide a network tester or analyzer that can be implemented in any network environment.

Other objects and advantages of the present invention will in part be obvious, and in part appear hereinafter.

### SUMMARY OF THE INVENTION

In accordance with the foregoing objects and advantages, the present invention provides a device for interconnecting a series of computer network cables to a computer network analyzer. The device comprises an upper chassis and a lower chassis that are interconnected to one another in part via a pair of corresponding tracks and channels, and in part via mating interconnect members. The upper chassis includes a printed circuit board attached to its plate that contains a plurality of passive circuit components, and incorporates standard network cable connectors in its rear panel. The lower chassis contains a printed circuit board with active switch and testing/analyzing components disposed thereon. The lower chassis' printed circuit board provides a tapped data traffic stream for forwarding to test or analysis equipment (collectively referred to as “analyzers,” or an equivalent thereof) through connectors that engage the connectors incorporated into the rear panel of the upper chassis when the lower and upper chassis are fully interconnected. Once the network input and output cables are connected to the cable connectors incorporated into the upper chassis, full network operation is possible, with electronic data flow being interrupted only upon removal or disconnection of a cable. However, the network connections can be maintained even in the event of the active circuit board in the lower chassis malfunctioning, losing power, or needing replacement or repair.

### BRIEF DESCRIPTION OF THE DRAWINGS

The present invention will be more fully understood and appreciated by reading the following Detailed Description in conjunction with the accompanying drawings, in which:

FIG. 1 is an exploded perspective of the present invention without a cover;

FIG. 2 is a perspective view of the present invention without a cover;

FIG. 3 is an exploded perspective of the present invention using an alternative type of interconnect;

FIG. 4 is a perspective view of the embodiment of FIG. 3 shown with a cover;

FIG. 5 is a front elevation view of the present invention; and

FIG. 6 is a rear elevation view of the present invention.

### DETAILED DESCRIPTION

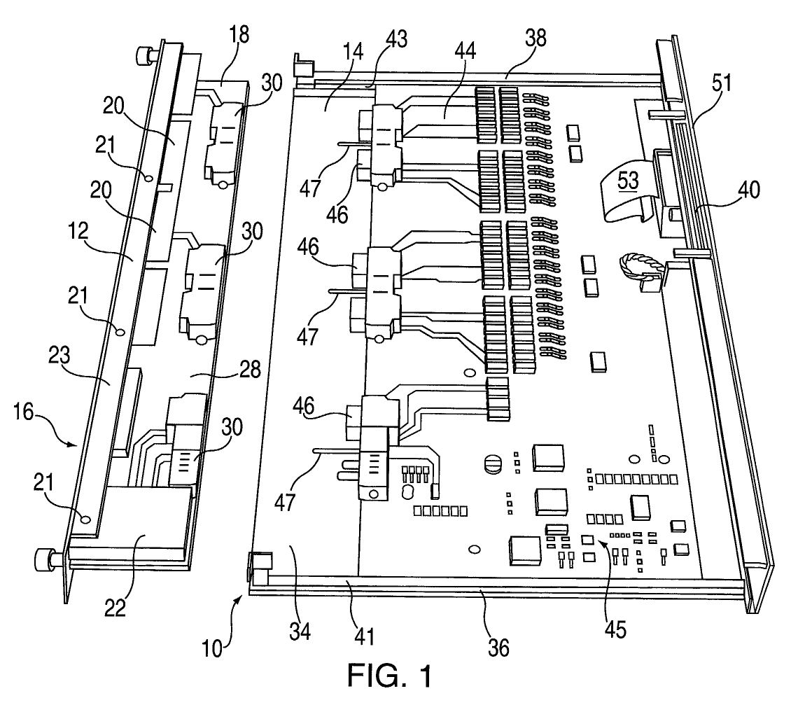

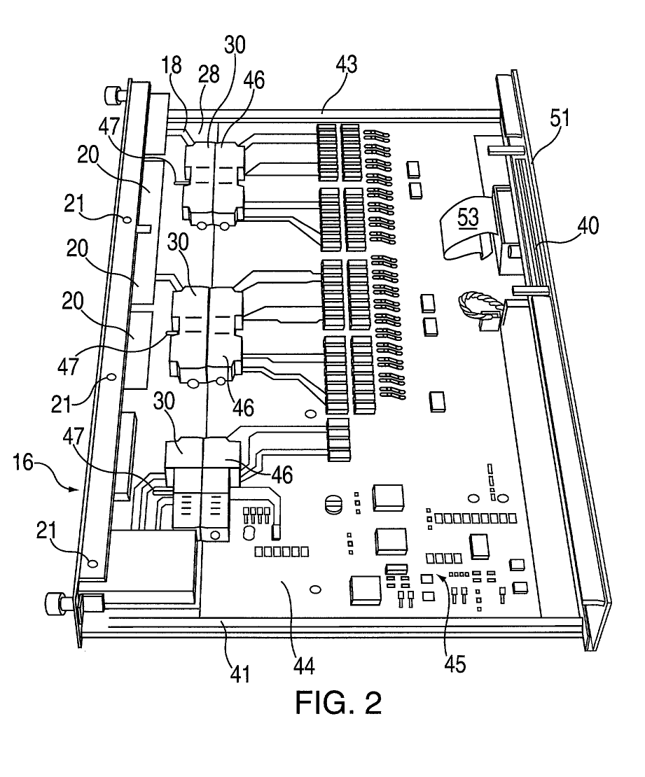

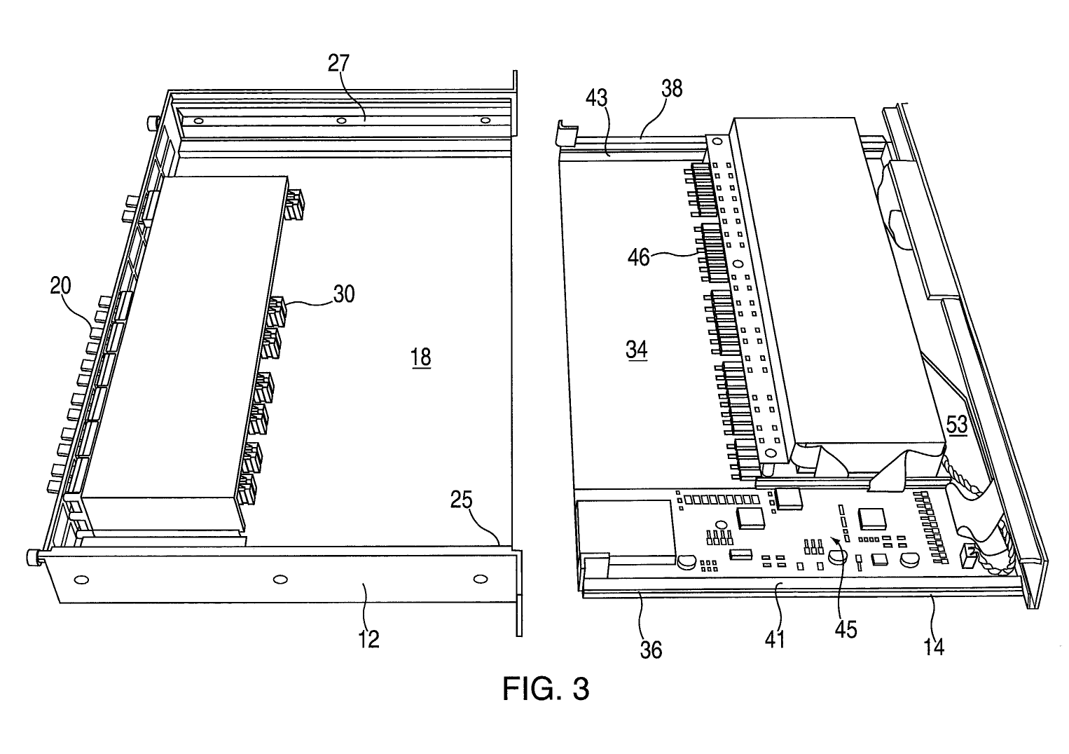

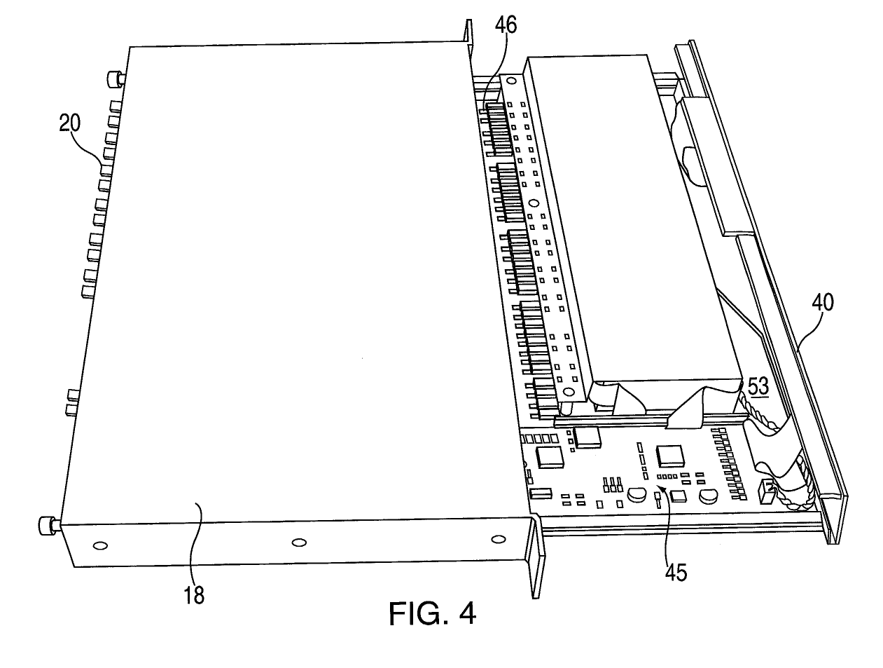

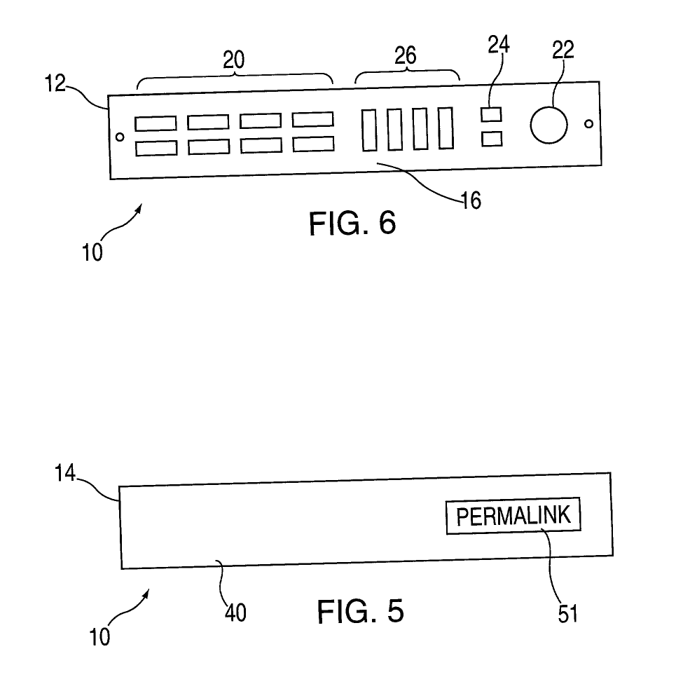

Referring now to the drawings, in which like reference numerals refer to like parts throughout, there is seen in FIG. 1 a device, designated generally by reference numeral 10, comprising an upper chassis 12 and a lower chassis 14 interconnected to one another. Device 10 permits electronic data traffic across a network to be maintained during normal operating conditions, as well as during power failures that result from power source interruption and active switch component failures or during channel switching. In addition, as further described herein, the active circuit board components which form a part of device 10 are adapted for field replacement with no interruption of network data flow, and with individual tap ports to all network segments continuing to be available.

Upper chassis 12 comprises a rear panel 16 extending upwardly from a floor panel 18, and a cover 19 attached thereto via a series of bolts, or equivalent connectors, which extend theretrough and engage openings 21 formed through a flanged lip 23 extending inwardly from the upper edge of rear panel 16. A pair of opposing, elongated channels 25, 27 are formed in the inner side walls of cover 19.

A series of industry standard network link interconnects 20, such as 8-pin modular or SC type connectors, are attached to rear panel 16, as are a power supply 22, an external computer control connector 24, and a series of test/analyzer connectors 26 (again, device 10 can include any kind of conventional testing or analyzing circuitry used to monitor and test computer networks). A printed circuit board 28 is attached to floor panel 18, and includes a series of the “male” halves of “hot swap” interconnects 30 attached thereto and conductively coupled via conductive wiring incorporated into board 28 to network interconnects 20, power supply 22, external computer connector 24, and test/analyzer connectors 26 (it should be understood that most any type of industry standard interconnect would work with the present invention, and that “hot swap” interconnects are simply the preferred embodiment due to their ability to operate with or without power). The male halves of hot swap interconnects 30 include an opening 32 formed therein, as well as conductive male elements.

Lower chassis 14 comprises a floor panel 34, a pair of opposing side panels 36, 38, and a front panel 40 all extending upwardly from floor panel 34. A pair of opposing, elongated tracks 41, 43 are attached to the inner surfaces of side panels 36, 38, respectively. A printed circuit board 44 is attached to floor panel 40 and contains active circuitry elements, designated generally by reference numeral 45, arranged thereon, such as switches, test and control circuits, and a visual display circuit. A visual display 51, such as an LCD, is incorporated into front panel 40 and is operably connected via ribbon cable 53 to active circuitry 45. A series of female halves of hot swap interconnects 46 are also attached to printed circuit board 44, with each having an alignment pin 47 and conductive female receptacles. Female halves of hot swap interconnects 46 are conductively coupled to the active circuit elements 45 via conductive wiring embedded in board 44. A pair of opposing, threaded openings 48, 50 are formed in lower chassis 14 at the comers of its rear edge.

Upper chassis 12 is interconnected to lower chassis 14 in part by a pair of threaded rods 52, 54 which pass through rear panel 16 and threadably engage openings 48, 50, respectively, and in part by channels 25, 27 engaging tracks 41, 43, respectively. When the two chassis are interconnected, male halves of hot swap interconnects 30 operably engage female halves of hot swap interconnects 46, with alignment pins 47 engaging openings 32 and the conductive male elements engaging the conductive female receptacles. When these connections are established, network link interconnects 20 (as well as power supply 22, external computer connector 24, and test/analyzer connectors 26) are conductively interconnected to the active circuit elements 45 disposed on printed circuit board 44. Thus, computer network segments may be interconnected to active circuitry 45 through the male and female hot swap interconnects 30 and 46.

By establishing connectivity between network interconnects 20, power supply 22, external computer connector 24, and analyzer connectors 26, via upper chassis 14 and lower chassis 16, as described above, it is unnecessary to disconnect network segments from upper chassis 12 when active circuit elements 45 fail or require replacement. Rather, upper chassis 12 can simply be detached from lower chassis 14 to perform the necessary maintenance. It is possible that no detachment of parts is necessary to perform the maintenance, and that all vital connections can be maintained while performing the necessary maintenance, thereby leading to minimal network down time. In addition, if there is a power interruption to active circuit elements 45, it will not effect any of the network segment connections.

What is claimed is:

1. A device for interconnecting a computer network segment cable to a computer network analyzer, comprising:
a. an upper chassis having a first plate and at least one network cable interconnect;
b. a lower chassis interconnected to said upper chassis and having a second plate;
c. a first set of circuit components mounted to said second plate;
d. a first interconnect element attached to said first plate and conductively coupled to said network cable interconnect; and
e. a second interconnect element attached to said second plate and conductively connected to said first set of circuit components, said second interconnect element adapted for conductive coupling to said first interconnect element.

2. The device according to claim 1, wherein said first set of circuit components comprise active circuits.

3. The device according to claim 2, wherein said active circuit elements comprise network analyzer circuitry.

4. The device according to claim 2, wherein said active circuit elements comprise switching circuitry.

5. The device according to claim 1, further comprising a cover attached to said upper chassis.

6. The device according to claim 5, wherein said cover includes a first pair of opposing sidewalls and first and second channels attached to respective ones of said first pair of sidewalls.

7. The device according to claim 6, wherein said lower chassis includes a second pair of opposing of sidewalls upstanding from said second plate.

8. The device according to claim 7, wherein said lower chassis further includes first and second tracks attached to respective ones of said second pair of sidewalls.

9. The device according to claim 8, wherein said lower chassis is interconnected to said upper chassis by said first and second tracks engaging said first and second channels, respectively.

10. The device according to claim 1, wherein said at least one network interconnect is an 8-pin modular connector.

11. The device according to claim 1, wherein said at least one network interconnect is an SC connector.

12. A device for interconnecting a computer network segment cable to a computer network analyzer, comprising:
a. a first chassis having a network cable connector and a first interconnect element attached thereto, said cable connector and first interconnect member being conductively interconnected;
b. a second chassis having a printed circuit board and a second interconnect element attached thereto, said printed circuit board and said second interconnect member being conductively interconnected; and
c. means for conductively and removably interconnecting said first interconnect member to said second interconnect member, whereby said cable connector is conductively interconnected to said printed circuit board.

13. The device according to claim 12, wherein said means for conductively and removably interconnecting said first interconnect member to said second interconnect member comprises:
a. said first interconnect member including a male conductive element;
b. said second interconnect member including a female conductive element that removably engages said male conductive element, thereby establishing a removable and conductive interconnection.

14. The device according to claim 12, wherein said first chassis further comprises a first pair of opposing sidewalls and first and second channels attached to respective ones of said first pair of sidewalls.

15. The device according to claim 14, wherein said second chassis further comprises a second pair of opposing sidewalls having first and second tracks attached to respective ones of said second pair of sidewalls.

16. The device according to claim 15, wherein said first chassis is connected to said second chassis by said first and second channels engaging said first and second tracks, respectively.

17. The device according to claim 12, wherein said network cable connector is an 8-pin modular connector.

18. The device according to claim 12, wherein said network cable connector is a SC type connector.

19. The device according to claim 12, further comprising a visual display attached to said second chassis.

20. The device according to claim 12, wherein said first chassis includes a printed circuit board having passive circuit elements disposed thereon which conductively interconnect said network cable connector to said first interconnect member.
